(19) United States
(12) Patent Application Publication
(10) Pub. No.: US 2006/0020455 A1
(43) Pub. Date: Jan. 26, 2006

(54) Adaptive plug-in architecture for mix-mode personal communication

(75) Inventor: Prashant R. Velagaleti, Carpentersville, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc., Schaumburg, IL (US)

(21) Appl. No.: 10/896,221

(22) Filed: Jul. 20, 2004

(51) Int. Cl. G10L 15/26

(52) U.S. Cl. 704/235

(57) ABSTRACT

A method (100) and apparatus for providing an application over a peer-to-peer network (200). During a communication session in the peer-to-peer network, data having a first format (240) can be transferred from a first device (205) in the peer-to-peer network to at least a second device (210) in the peer-to-peer network. Responsive to a predetermined event occurring during the transfer of the first data, data having a second format (245) can be transferred from the first device to the second device and/or a third device in the peer-to-peer network. The second data can include one or more data objects. Application data (250) for an application configured to process the second data then can be automatically transferred from the first device to the second device and/or the third device. The application data can include a data file containing the application or a location identifier for a location containing the application.

### BACKGROUND OF THE INVENTION

1. Field of the Invention

The present invention generally relates to communications systems, and more particularly to voice communications systems.

2. Description of Related Art

Mobile communication devices, such as mobile telephones and personal digital assistants (PDAs), are becoming ubiquitous throughout much of the world. Indeed, many people consider such devices an essential part of modern living. Spurring their adoption by consumers is a wide range of functionality now being designed into the devices. For instance, mobile communication devices that include computer applications, Internet access, text messaging and integrated digital cameras are now available.

Oftentimes, files are transferred between mobile communication devices. For example, a user can take a picture with his mobile communication device's integrated camera and wirelessly transfer the picture to another user, who then can access the picture on his own mobile communication device. Users also can wirelessly transfer data and application files to one another. Unfortunately, a particular file that is transferred is not always immediately accessible by the mobile communication device to which it was transferred. For example, certain files require additional non-content data, such as plug-ins, to be installed on the device before the device can perform desired operations on the files.

A plug-in is an application that supplements the operation of another application, thereby expanding its capabilities. For instance, plug-ins commonly are provided to expand the capabilities of Internet browsers. If the plug-in is not currently resident on the mobile communication device, the mobile communication device user is required to contact a server to initiate download and installation of the plug-in before the file can be processed. This process is inconvenient to most users.

### SUMMARY OF THE INVENTION

An embodiment in accordance with the present invention concerns an apparatus and a method for providing an application over a peer-to-peer network. During a communication session in the peer-to-peer network, data having a first format (first data) can be transferred from a first device in the peer-to-peer network to at least a second device in the peer-to-peer network. For example, the communication session can be a voice communication session in which voice data is transferred, or the communication session can be an instant messaging session in which text data is transferred. Moreover, the first and second devices can be mobile communication devices, such as mobile telephones or personal digital assistants (PDAs).

Responsive to a predetermined event occurring during the transfer of the first data, data having a second format (second data) can be transferred from the first device to the second device and/or a third device in the peer-to-peer network. For instance, the second data can be transferred in response to a user input during the first communication session. The second data can include one or more data objects.

Application data for an application configured to process the second data then can be automatically transferred from the first device to the second device and/or the third device. The application data can include a data file containing the application. Alternatively, the application data can include a location identifier for a location containing the application. Finally, the application can include at least one plug-in.

### BRIEF DESCRIPTION OF THE DRAWINGS

FIG. 1 is a flow chart presenting a method for providing an application over a peer-to-peer network in accordance with an embodiment of the present invention.

FIG. 2 is a diagram of a communications network in accordance with an embodiment of the present invention.

### DETAILED DESCRIPTION

An embodiment in accordance with the present invention relates to a method for providing adaptive plug-in architecture for mix-mode communication. More particularly, when a data object is transferred from a first user to a second user in a peer-to-peer network, an application required to perform particular operations on the data object—for example, a plug-in—can be automatically provided to the second user's communication device (second device). As defined herein, a peer-to-peer network is a network in which two or more nodes having equivalent status on the network can initiate communication with each other. Notably, the communication can be propagated directly from a first of the nodes to a second of the nodes, or propagated from the first node to the second node via a server, switch or hub.

In one arrangement, the application can be transferred from the first user's communication device (first device) to the second device. Alternatively, a location identifier, such as a uniform resource locator (URL), can be transferred to the second device. The location identifier can be used by the second device to automatically download and install the appropriate application. Accordingly, the second device can be conveniently provided with the capability to process the data objects without requiring a user to manually locate and install applications necessary for the task.

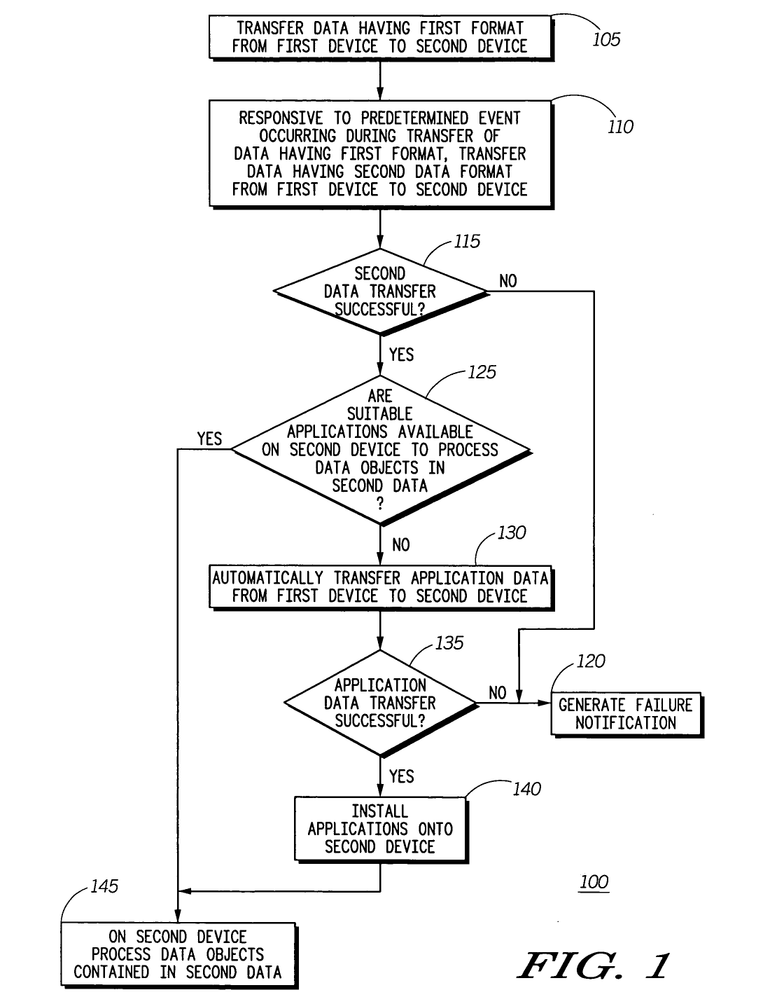

A flowchart is shown in FIG. 1, which presents a method for providing an application over a peer-to-peer network in accordance with an embodiment of the present invention. As illustrated therein, the method 100 can include several steps. Beginning at step 105, the first device can commence transferring data having a first format (first data) over a peer-to-peer network to the second device. As defined herein, the transfer of data means moving or copying data from one location to another. The first format can be any data format useful for communicating data. For example, in the case that users of the first and second devices are engaged in a voice communication session, the first data can be data containing voice information. In the case that the users are engaged in an instant messaging communication session, the first data can contain text information. Still, other data formats can be used for the first data and those skilled in the art will appreciate that the invention is not limited in this regard.

Proceeding to step 110, responsive to a predetermined event occurring during the first data transfer, data having a second format (second data) can be transferred from the first device to the second device. The second data can include one or more data objects. As defined herein, a data object is anything that can exist in data storage and on which operations can be performed, such as files, programs, or arrays. The predetermined event occurring during the first data transfer can be a command automatically initiated by the first device or the second device. For instance, the data object can include user information that is automatically transferred between the communication devices when a communication link is established between the devices. The predetermined event alternatively can be initiated by one or more user inputs received by the first or second devices. For example, a first user can enter input commands into the first device to transfer a document file to the second device.

In an alternate arrangement, the second data can be transferred from the first device to a third communication device (third device) in response to a predetermined event occurring during a peer-to-peer communication session between the first device and the second device. For example, the predetermined event can include a user initiating transfer of the second data to the third device. Still, one skilled in the art will appreciate that other peer-to-peer communication scenarios can be implemented that are within the scope of the present invention.

Continuing at decision box 115, if the second data transfer is unsuccessful, a failure notification can be generated, as shown at step 120. Notably, determination of whether the second data transfer is successful can be made after the download of the second data is complete, or while the second data is being streamed to the second device. Accordingly, the failure notification also can be generated if an unexpected interruption occurs when the second data is being streamed.

If the second data transfer is successful, at step 125 a determination can be made as to whether the second device has applications suitable for processing the data objects contained in the second data. For example, each device can be provided with a data table to cross reference file name extensions to applications installed on the device. The invention is not limited in this regard, however. Any means for determining whether suitable applications are available on the second device is within the scope of the present invention. If the second device has suitable applications, such applications can be used to process the data objects contained in the second data, as shown in step 145.

If the second device does not have all suitable applications for processing the data objects contained in the second data, the second device can automatically notify the first device which data objects it cannot process and/or which applications the second device is lacking. The first device then can automatically transfer the application data to the second device, as shown in step 130. For example, the first device can propagate application data correlating to applications requested by the second device, or applications that are pre-determined to be required for processing the data objects.

In one arrangement, the application data can include one or more data files containing applications required to process the data objects. For example, the data files can contain Web browser plug-ins, which are well known to the skilled artisan. Alternatively, the application data can include a location identifier, for instance a uniform resource locator (URL), which can be used by the second device to connect to a location containing the applications required to process the data objects. The applications then can be automatically downloaded and installed onto the second device.

Referring to decision box 135 and again to step 120, a failure notification can be generated if the transfer of the application data is unsuccessful. If the application data transfer is successful, however, the method can continue to step 140 where the applications required to process the data objects may be automatically installed onto the second device, subject to any necessary security verification or user permissions. For instance, one or more plug-ins for codecs can be installed as part of an image viewer. Proceeding to step 145 the second device can use the applications to process the data objects contained in the second data.

In the alternate arrangement discussed in which the second data was transferred from the first device to the third device, steps 110 through 145 can be followed. In this arrangement, however, the reader should substitute references to the second device in steps 110 through 145 with references to the third device.

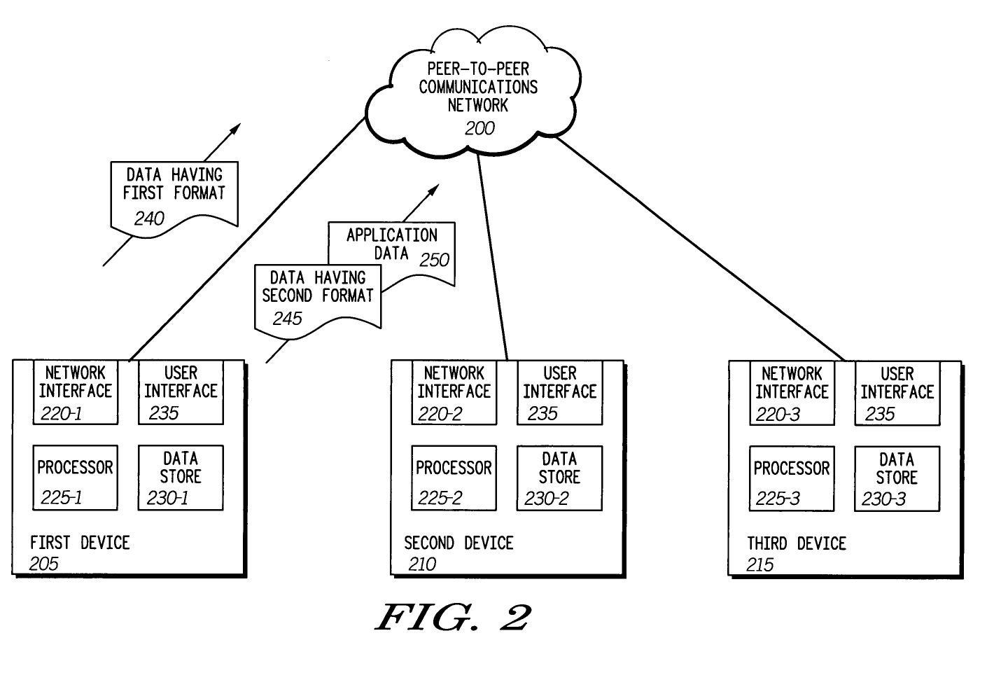

FIG. 2 depicts an example of a peer-to-peer communications network 200 in which the aforementioned method can be implemented. The peer-to-peer communications network 200 can include two or more communication devices communicatively connected by landline and/or wireless communication links. For example, the peer-to-peer network 200 can include a first device 205, a second device 210 and a third device 215. The peer-to-peer communications network 200 can comprise a mobile radio communications network, a cellular telephone communications network, a telemetry system, a wide area network (WAN), a local area network (LAN), an intranet, the Internet, and/or any other suitable communications network.

The first, second and third devices 205, 210, 215 can be any suitable communication devices capable of communicating over the peer-to-peer communications network 200. For example, the first, second and third devices 205, 210, 215 can be computers, Internet appliances, mobile communication devices, such as personal digital assistants (PDAs) or mobile telephones having interconnect and/or dispatch capability, and the like. In another arrangement, the third device 215 can be a display, an audio system or a multimedia system that can receive data transfers over the peer-to-peer communications network 200.

The devices 205, 210, 215 each can comprise a network interface 220, a processor 225, a data store 230 and a user interface 235. As shown in FIG. 2, each of the reference numerals for these components is supplemented with a number that identifies the appropriate first (1), second (2) or third (3) device. Each of the network interfaces 220 can be a landline or a wireless network interface. For example, the network interfaces 220 can be modems, LAN or WAN interfaces, or radios having interconnect and/or dispatch capabilities. The processors 225 can be central processing units (CPUs), digital signal processors (DSPs), application specific integrated circuits (ASICs), or any other processors suitable for processing data transmitted and/or received over the communications network 200.

Each of the data stores 230 can comprise an electronic storage medium, such as read only memory (ROM), flash memory or random access memory (RAM), a magnetic storage medium (e.g. a hard disk drive), an optical storage medium, a magneto-optical storage medium, or any other suitable data storage device. For example, each of the data stores 230 can be a subscriber identity module (SIM) card. SIM cards can identify user accounts under which the devices 205, 210, 215 are operated, handle authentication of the devices 205, 210, 215, and provide data storage for user data such as telephone numbers and information about the peer-to-peer network 200. SIM cards may also contain applications that run on the devices 205, 210, 215. Further, each of the user interfaces 235 can comprise a keypad, a display, input and output audio transducers, and/or any other means for interfacing with the communication devices 205, 210, 215.

During a communication session in which the first and second devices 205, 210, 215 are communicatively linked, the first device 205 can transfer data 240 having a first format to the second device 210. The first device 205 also can transfer data 245 having a second format. For instance, the data 245 can be transferred from the data store 230-1 to the data store 230-2. The data 245 can include one or more data objects. In response to a predetermined event, the processor 225-1 can initiate the transfer of the data 240, 245 over the peer-to-peer communications network 200 via the network interface 220-1. The processor 225-2 can receive the data 240, 245 over the peer-to-peer communications network 200 via the network interface 220-2.

In some instances the second device 210 will lack applications necessary to perform desired operations on the data objects. As noted, the second device 210 can notify the first device 205 of which data objects it cannot operate upon, and/or which applications are required to process the data objects. To conveniently provide a user of the second device 210 the necessary applications, the first device 205 can automatically transfer application data 250 from the data store 230-1 to the data store 230-2 of the second device 210. As noted, the application data 250 can contain the required applications, which then can be automatically installed onto the second device 210, or the application data 250 can provide a location identifier which can be used by the second device 210 to automatically download and install the appropriate applications. Again, the processor 225-1 can initiate the transfer of the application data 250 over the peer-to-peer communications network 200 via the network interface 220-1.

In one arrangement, responsive to a predetermined event occurring during the transfer of data 240 from the first device 205 to the second device 210, the second data 245 can be automatically transferred to the third device 215. As with data transfers previously described, if the third device 215 does not have the applications to process data objects contained in the second data 245, the first device 205 can automatically transfer application data 250 from the data store 230-1 to the data store 230-3 of the third device 215. The processor 225-3 can receive the second data 245 and the application data 250 over the peer-to-peer communications network 200 via the network interface 220-3.

The present invention can be realized in hardware, software, or a combination of hardware and software. The present invention can be realized in a centralized fashion in one system, or in a distributed fashion where different elements are spread across several interconnected systems. Any kind of communication device or other apparatus adapted for carrying out the methods described herein is suited. A typical combination of hardware and software can be a communication device with an application that, when being loaded and executed, controls the processing device such that it carries out the methods described herein.

The present invention also can be embedded in an application program product, which comprises all the features enabling the implementation of the methods described herein, and which when loaded in a communication device is able to carry out these methods. Application program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for providing an application over a peer-to-peer network, comprising:
during a communication session in the peer-to-peer network, transferring data having a first format from a first device in the peer-to-peer network to at least a second device in the peer-to-peer network;
responsive to a predetermined event occurring during the transfer of data having the first format, transferring data having a second format from the first device to at least one of the second device and a third device in the peer-to-peer network; and
automatically transferring application data for an application configured to process the data having the second format from the first device to at least one of the second device and the third device.

2. The method according to claim 1, further comprising the step of selecting the communication session to be a voice communication session.

3. The method according to claim 1, further comprising the step of selecting the communication session to be an instant messaging communication session.

4. The method according to claim 1, further comprising the step of selecting at least one of the devices to include a mobile communication device.

5. The method according to claim 4, further comprising the step of selecting the mobile communication device to be at least one device selected from the group consisting of a mobile telephone and a personal digital assistant (PDA).

6. The method according to claim 1, further comprising the step of selecting the application to include at least one plug-in.

7. The method according to claim 1, further comprising the step of selecting the application data to include a data file containing the application.

8. The method according to claim 1, further comprising the step of selecting the application data to include a location identifier for a location containing the application.

9. The method according to claim 1, further comprising the step of selecting the predetermined event to be a reception of a user input.

10. An apparatus for providing an application over a peer-to-peer network, comprising a processor that performs the steps:
during a communication session in the peer-to-peer network, transferring data having a first format from a first device in the peer-to-peer network to at least a second device in the peer-to-peer network;
responsive to a predetermined event occurring during the transfer of data having the first format, transferring data having a second format from the first device to at least one of the second device and a third device in the peer-to-peer network; and
automatically transferring application data for an application configured to process the data having the second format from the first device to at least one of the second device and the third device.

11. The apparatus of claim 10, wherein the communication session is a voice communication session.

12. The apparatus of claim 10, wherein the communication session is an instant messaging communication session.

13. The apparatus of claim 10, wherein at least one of the devices is a mobile communication device.

14. The apparatus of claim 13, wherein the mobile communication device is selected from the group consisting of a mobile telephone and a personal digital assistant (PDA).

15. The apparatus of claim 10, wherein the application is a plug-in.

16. The apparatus of claim 10, wherein the application data includes a data file containing the application.

17. The apparatus of claim 10, wherein the application data includes a location identifier for a location containing the application.

18. The apparatus of claim 10, wherein the predetermined event is a reception of a user input.
